(19) United States
(12) Patent Application Publication
(10) Pub. No.: US 2014/0379763 A1
(43) Pub. Date: Dec. 25, 2014

(54) SYSTEM FOR UNIQUELY IDENTIFIED IMMUTABLE DATA RECORDS

(71) Applicant: Rishabh Jain, Champaign, IL (US)

(72) Inventor: Rishabh Jain, Champaign, IL (US)

(21) Appl. No.: 14/295,065

(22) Filed: Jun. 3, 2014

Related U.S. Application Data
(60) Provisional application No. 61/838,879, filed on Jun. 25, 2013.
(60) Provisional application No. 61/840,242, filed on Jun. 27, 2013.

(51) Int. Cl. G06F 17/30; G06F 21/62

(52) U.S. Cl. CPC G06F 17/30312; G06F 21/6218
USPC 707/812

(57) ABSTRACT

A system for storing records including a controller that performs the steps of: receiving data, via a user interface, from a user; storing, in the database, a record including the data, a timestamp of the time the data was received by the controller, and a unique identifier, wherein the unique identifier includes one or more digits, wherein the one or more digits of the unique identifier include one or more digits of the timestamp and a serial number; displaying, via the user interface, a confirmation screen including the unique identifier; receiving a request, including a second unique identifier, for a data record associated with the second unique identifier; retrieving, from the database, a the data record associated with the second unique identifier; and displaying, via the user interface, a data and a timestamp of the data record associated with the second unique identifier.

### CROSS-REFERENCE TO RELATED APPLICATIONS

This application incorporates by reference and claims priority to U.S. Provisional Patent Application No. 61/838,879 filed Jun. 25, 2013, and U.S. Provisional Patent Application No. 61/840,242 filed Jun. 27, 2013.

### BACKGROUND OF THE INVENTION

The present subject matter relates generally to systems and methods for a user to submit data and receive a unique identifier for accessing an immutable record of the data. More specifically, the present invention relates to a system that allows a user to submit data forming a record of text, photos, sound and/or video and receive a unique identifier of the record submitted, wherein the unique identifier enables a bearer of the unique identifier to access the immutable record of the data submitted.

In many social, legal, professional, and other situations, there is a need to prove that various statements were made at a certain time, or to show that certain information was in an individual's possession at a particular time. Previous methods of solving this need involved obtaining witnesses or notaries who could testify to the individual's possession of the information. However, these previous solutions are cumbersome, if not completely unworkable in certain instances. Thus, there is a need for new mechanisms to prove that various statements were made at a certain time, or to show that certain information was in an individual's possession at a particular time.

Accordingly, there is a need for systems and methods of proving the possession of information at a particular time, as described herein.

### BRIEF SUMMARY OF THE INVENTION

To meet the needs described above and others, the present disclosure provides a records system for creating uniquely identified immutable data records. The records system provides a mechanism to create an indelible record that can serve as proof of various statements made at a certain time as is needed in many social, legal, professional and other situations without requiring an e-mail, mailing address, or other identification.

In an embodiment, the records system allows anyone to submit data consisting of text and/or photos, sound, and video and to receive a unique identifier of the record submitted. A user sends data to the records system via a user interface. In response to receiving the data, the records system, stores the data, generates a unique identifier to identify the data record created, and transmits the unique identifier to the user. At a later time, the user, or any other user having received the unique identifier, may access the data by providing the unique identifier.

The records system may include a controller to execute instructions for carrying out the tasks of the records system. A database may be in communication with the controller to store the data records. A user interface may be in communication with the controller to present screens to the user to carry out the functions of the records system. The user interface of the records system may be embodied in a website.

When a user first accesses the records system, the user may be presented with an opening screen and may choose whether to make a record or to retrieve a previously created record. Upon choosing to make a record, the user is presented with a record creation screen via the user interface. The user may then enter text, upload photos, sounds, videos, or other files, or otherwise provide data to include in the record. Upon adding all the information desired, the user may trigger the “PLACE RECORD” prompt to trigger the records system to create the record. In a preferred embodiment, the records system does not ask for identifying information such as an email address, mailing address, etc.

After receiving the data from the user interface, the records system creates a data record. In an embodiment, a data record includes: the data submitted by the user, a timestamp, and a unique identifier. The timestamp represents the time that the data was received by the records system. As further described below, the unique identifier is a numerical or alphanumerical code that uniquely identifies a particular data record. The data record, including the data, the timestamp, and unique identifier, may be stored in the database for later access. The records system may further store integrity information in association with each data record. For example, the records system may create a cryptographic hash digest of the data record to create difficult-to-forge proof of the integrity of the information of the data record. The cryptographic hash may be stored in association with the data record.

In an embodiment, the unique identifier uniquely identifies the data record submitted, including the exact date and time of receipt of submission of the timestamp as measured in GMT (Greenwich mean time), along with a serial number. The time of the timestamp may be measured in milliseconds. Additionally, in a preferred embodiment, the serial number may be a random number, a sequential number relating to the order of data as it is received by the records system, or a digest formed using a cryptographic hash, etc., or a combination of the previous. The unique identifier may include the timestamp, and serial number in an ordered fashion.

In a preferred embodiment, the unique identifier is constructed by concatenating the information in the following order: the first two digits representing the month; the next two digits representing the day; the next four digits representing the year; the next two digits representing the hours in twenty-four hour format; the next two digits representing the minutes; then the next five digits representing the seconds, then three digits representing the milliseconds; and then a sequential number as the final fifteen digit serial number. The serial number may be encoded as numbers, alphabetical characters (both upper & lower case) and symbols.

In an alternative embodiment, the serial number of the unique identifier may include integrity information. The integrity information may be a cryptographic hash of the data. The serial number may have an alternate number of characters, for example, if the serial number is a SHA-256 cryptographic hash digest and is encoded in hexadecimal representation, the serial number may comprise sixty-four characters.

In yet another alternative embodiment, the serial number of the unique identifier may include a serial number including both a sequential number and integrity information. The integrity information may be a cryptographic hash truncated to a given number of digits, for example, fifteen digits.

After creating the data record, the user interface displays a confirmation screen. In an embodiment, the confirmation screen includes a confirmation of the receipt of the data and displays the unique identifier. In a preferred embodiment, the confirmation screen permits the user to view, save, printout, and/or email the data record.

Once the data record is created, it becomes available for access via a record access screen of the user interface. The user may be required to input information to retrieve a desired data record. In an embodiment, the unique identifier is required to access a data record. As shown, the user may submit the unique identifier to retrieve the data record.

Upon receiving a request for a data record, the records system retrieves the data record from the database. The data record may be retrieved from the database by the controller using the unique identifier. If there is any integrity information, the controller may check the data record for integrity. After retrieving the data record, the controller displays the data record to the user via a record display screen of the user interface.

An object of the invention is to provide a permanent record of data submitted to the system, which can never be deleted, altered or changed in any way.

An object of the invention is to provide a solution to allows anyone to view, access, print, save and/or e-mail the record provided the user has the unique identifier.

An advantage of the invention is that it provides a collection of indelible and unalterable data records known only to the submitter.

Another advantage of the invention is that it provides an indelible record that can serve as proof of various statements made at a certain time as is needed in many social, legal, professional and other situations.

A further advantage of the invention is that it incorporates a standardized date and time into the unique identifier number issued for that data record.

Yet another advantage of the invention is that no e-mail, address, or other identification is necessary.

Another advantage of the invention is that it provides only the person submitting the data has knowledge of the unique identifier number, and thus, that person can provide evidence of the possession of that information at that particular date and time of the data record.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a schematic diagram illustrating an example records system of the present disclosure.

FIG. 2 is a screenshot of a user interface showing an opening screen of the records system of FIG. 1.

FIG. 3 is a screenshot of a user interface showing a record creation screen of the records system of FIG. 1.

FIG. 4 is a diagram showing the components of an example data record of the records system of FIG. 1.

FIG. 5a is a diagram showing the alphanumerical digits of the unique identifier of the records system of FIG. 1 including a sequential number.

FIG. 5b is a diagram showing the alphanumerical digits of the unique identifier of the records system of FIG. 1 including integrity information.

FIG. 5c is a diagram showing the alphanumerical digits of the unique identifier of the records system of FIG. 1 including a sequential number and integrity information.

FIG. 6 is a screenshot of a user interface showing a confirmation screen of the records system of FIG. 1.

FIG. 7 is a screenshot of a user interface showing a record access screen of the records system of FIG. 1.

FIG. 8 is a screenshot of a user interface showing a record display screen of the records system of FIG. 1.

### DETAILED DESCRIPTION OF THE INVENTION

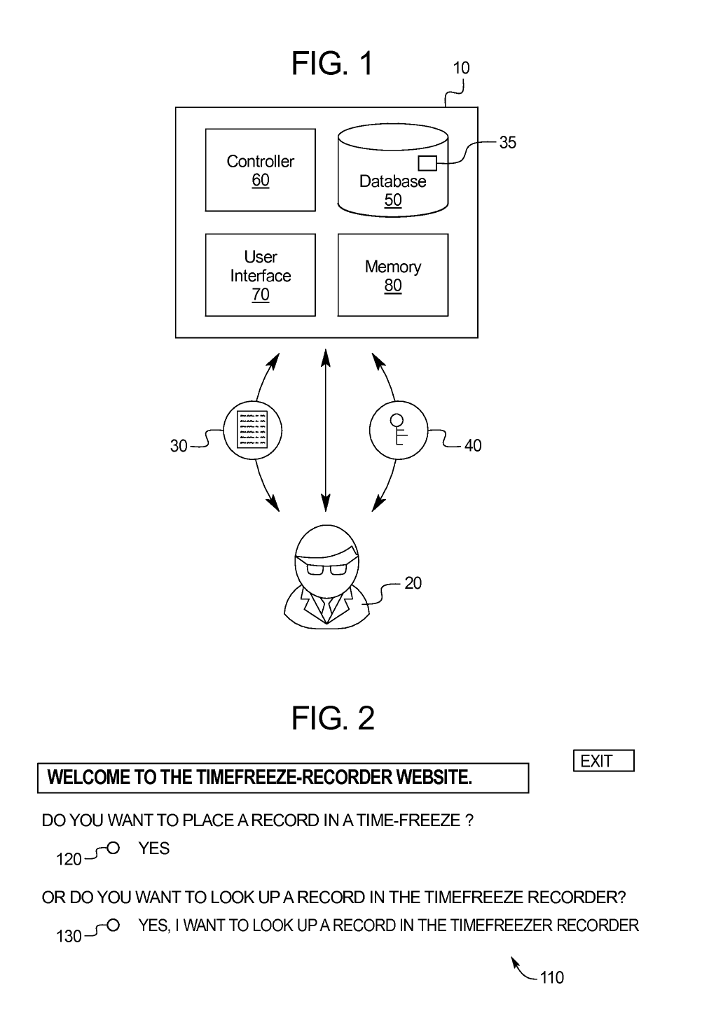

FIG. 1 illustrates an example of a system for uniquely identified immutable data records, herein called a records system 10. The records system 10 allows anyone to submit data 30 consisting of text and/or photos, sound and video and receive a unique identifier of the record submitted. As shown in FIG. 1, a user 20 communicates with the records system 10 via a user interface 70 to send data 30. In response to receiving the data 30, the records system 10 generates a unique identifier 40 to identify a data record 35 created to hold the data 30 and transmits the unique identifier 40 to the user 20. At a later time, the user 20 or any other user 20 having received the unique identifier 40 may access the data 30 by submitting the unique identifier 40.

FIG. 2 and FIGS. 6-8 are screenshots of an example of the user interface 70 of a records system 10 embodied in a website. As shown in FIG. 2, when a user 20 first accesses the records system 10, the user 20 is presented with an opening screen 110 and may choose whether to make a data record 35 by selecting the make record button 120 or to retrieve a previously created data record by selecting the retrieve record button 130.

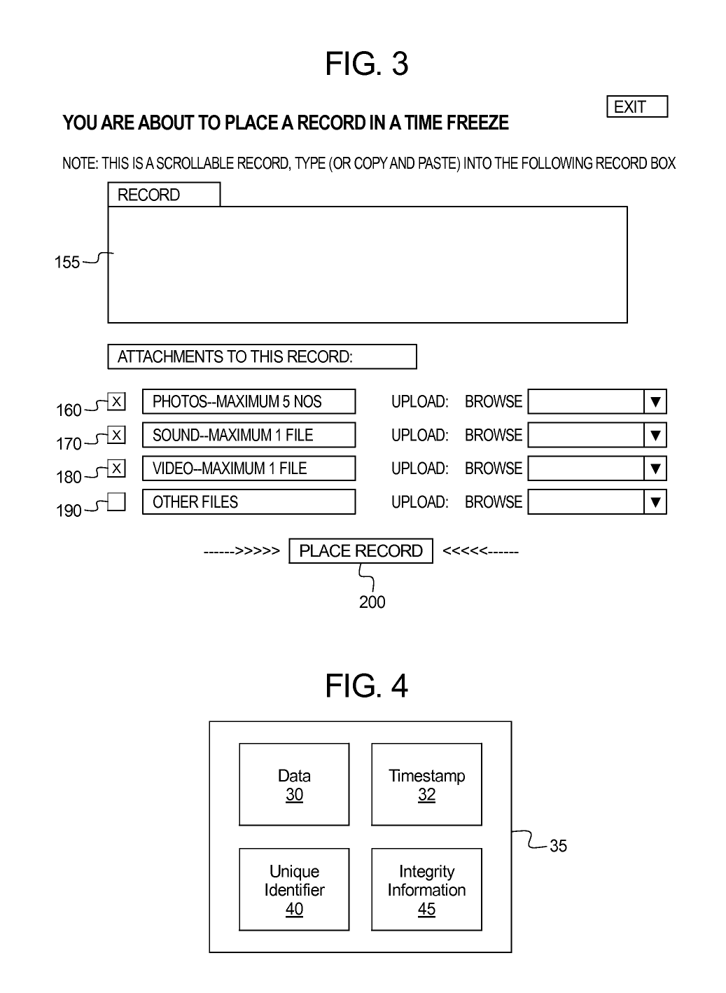

As shown in FIG. 3, upon choosing to make a data record, the user 20 is presented with a record creation screen 150 via the user interface 70. The user 20 may then enter text 155, upload photos 160, sounds 170, videos 180, or other files 190, or otherwise provide data 30 to include in the data record 35. Upon adding all the information desired, the user 20 may trigger the “PLACE RECORD” prompt 200 to trigger the records system 10 to create the data record 35.

After receiving the data 30 to record, the records system 10 creates a data record 35. As shown in FIG. 4, in an embodiment, a data record 35 includes: the data 30 submitted by the user 20, a timestamp 32, and a unique identifier 40. The timestamp 32 represents the time that the data 30 was received by the records system 10. The unique identifier 40, further described below, may be a numerical or an alphanumerical code that uniquely identifies a particular data record 35. The data record 35, including the data 30, the timestamp 32, and unique identifier 40, may be stored in the database 50 for later access. The records system 10 may further store integrity information 45 in association with each data record 35. For example, the records system 10 may create integrity information 45 including a cryptographic hash of the data record 35 to create a difficult to forge digest of the data record 35. The cryptographic hash may be stored in association with the data record 35.

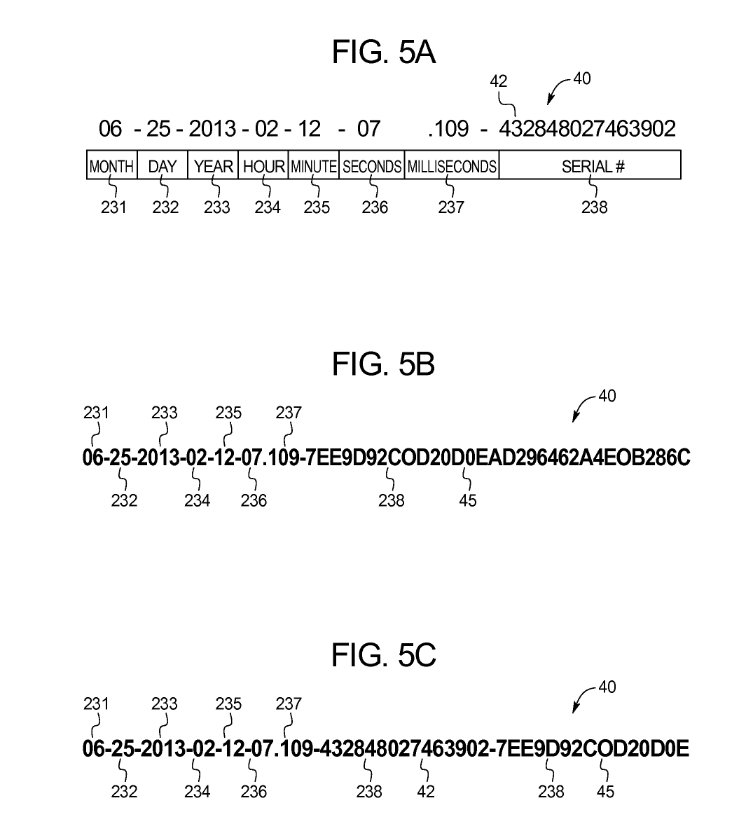

Turning to FIGS. 5a-5c, in an embodiment, the unique identifier 40 uniquely identifies the data record 35 submitted, including the exact date and time of receipt of submission of the timestamp 32 as measured in GMT (Greenwich mean time), along with a serial number 238. The time of the timestamp 32 may be measured in milliseconds. Additionally, in a preferred embodiment, the serial number 238 may be a random number, a sequential number 42 relating to the order of data 30 as it is received by the records system 10, or a digest formed using a cryptographic hash, etc., or a combination of the previous. The unique identifier 40 may include the timestamp 32, and serial number 238 in an ordered fashion.

As shown in FIG. 5a, in a preferred embodiment, the unique identifier 40 is constructed by concatenating the information in the following order: the first two digits representing the month 231; the next two digits representing the day 232; the next four digits representing the year 233; the next two digits representing the hours 234 in twenty-four hour format; the next two digits representing the minutes 235; then the next two digits representing the seconds 236, then three digits representing the milliseconds 237; and then a sequential number 42 as the final fifteen digit serial number 238. The serial number 238 may be encoded as numbers, alphabetical characters (both upper & lower case) and symbols.

In an alternative embodiment shown in FIG. 5b, the serial number 238 of the unique identifier 40 may include integrity information 45. The integrity information 45 may be a cryptographic hash of the data 30. The serial number 238 may have an alternate number of characters, for example, if the serial number 238 is a SHA-256 cryptographic hash digest and is encoded in hexadecimal representation, the serial number 238 may comprise sixty-four characters.

In yet another alternative embodiment, as shown in FIG. 5c, the serial number 238 of the unique identifier 40 may include a serial number 238 including both a sequential number 42 and integrity information 45. As shown in FIG. 5c, the integrity information 45 may be a cryptographic hash truncated to a given number of digits, in the shown example, fifteen digits. In a further embodiment, the serial number 238 of the unique identifier 40 may include a serial number 238 including a sequential number 42, integrity information 45, and a random number.

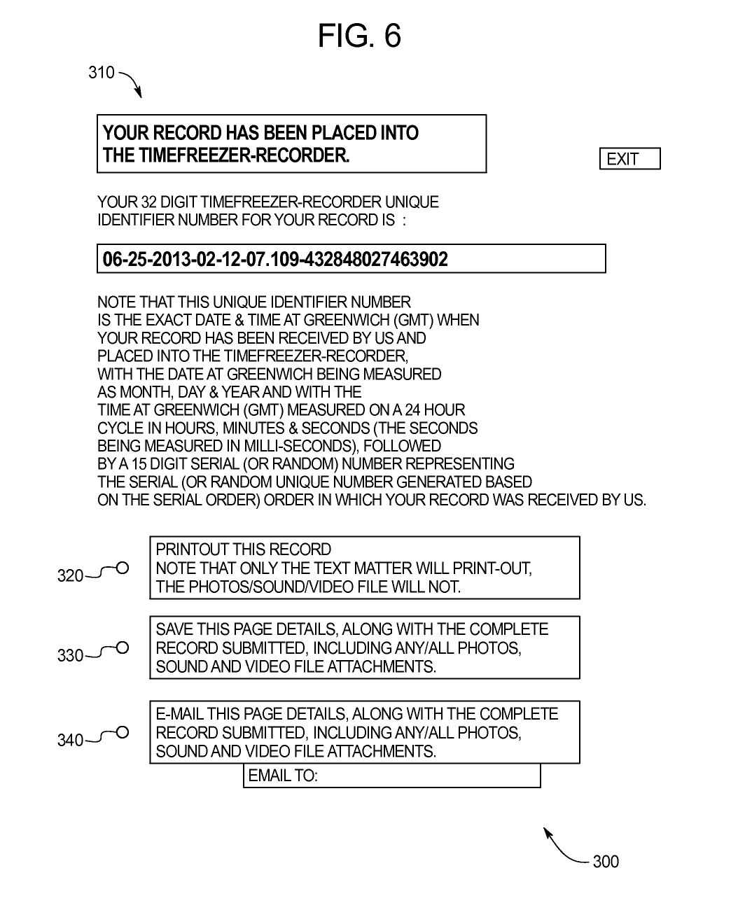

As shown in FIG. 6, after creating the data record, the user interface 70 displays a confirmation screen 300. In an embodiment, the confirmation screen 300 includes a confirmation message 310 regarding the receipt of the data 30 and displays the unique identifier 40. In a preferred embodiment, the confirmation screen 300 permits the user 20 to view, save 330, print 320, and/or email 340 the data record 35.

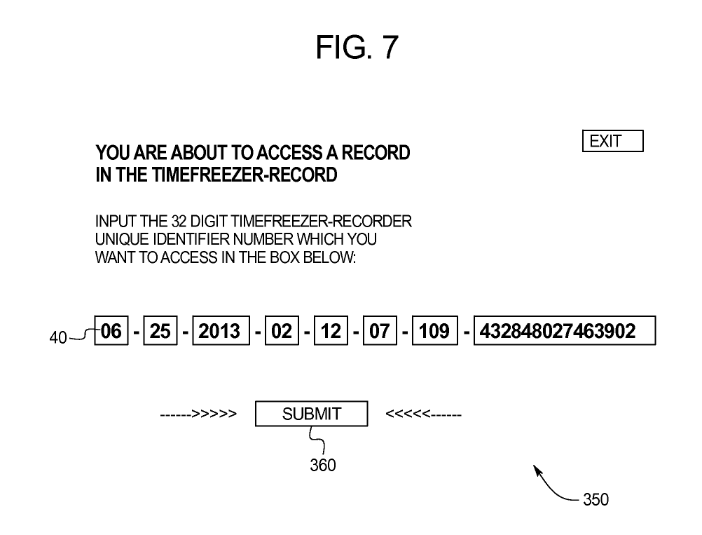

As shown in FIG. 7, after the creation of data record 35, it becomes available for access via the record access screen 350 of the user interface 70. The user 20 may be required to input information to retrieve a desired data record. In an embodiment, the unique identifier 40 is required to access a data record 35. As shown, the user 20 may enter the unique identifier 40 and hit submit 360 to retrieve the data record 35.

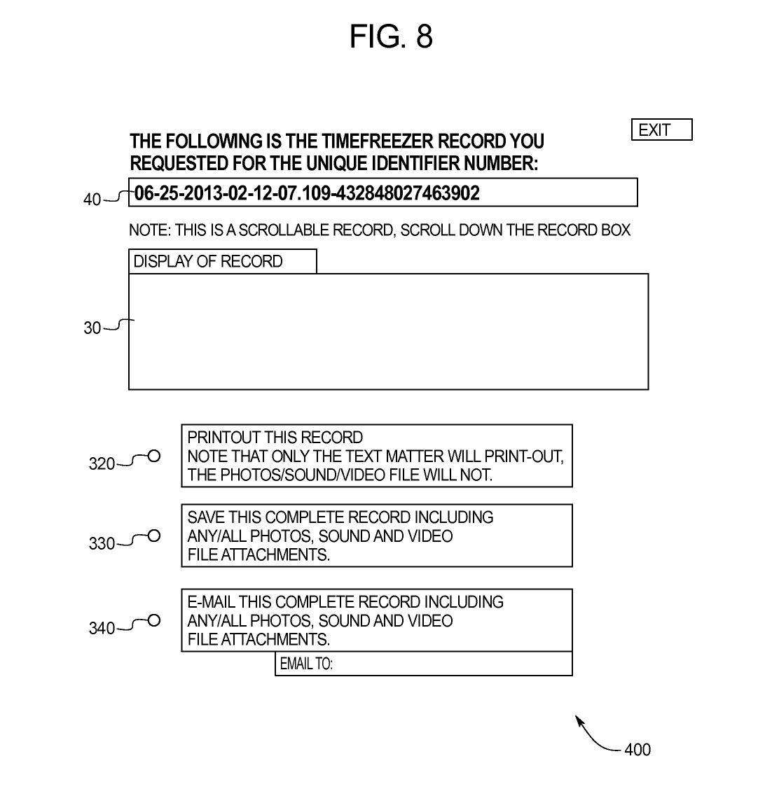

As shown in FIG. 8, after receiving a request for a data record 35, the records system 10 retrieves the data record from the database 50. The data record 35 may be retrieved from the database 50 by the controller 60 using the unique identifier 40. If there is any integrity information 45, the controller 60 may check the data record for integrity. After retrieving the data record 35, the controller 60 displays the data record to the user 20 via the record display screen 400 of the user interface 70. In a preferred embodiment, the record display screen 400 permits the user 20 to view, save 330, print 320, and/or email 340 the data 30 of the data record 35.

As described, a controller 60 controls aspects of the records system 10 described herein. The controller 60 may be embodied in one or more controllers 60 that may be adapted run a variety of application programs, access and store data, including accessing and storing data in the associated database 50 (which may be embodied in one or more databases 50), and enable one or more interactions with the other components of the records system 10. Typically, the one or more controllers 60 are embodied in one or more programmable data processing devices. The hardware elements, operating systems, and programming languages of such devices are conventional in nature, and it is presumed that those skilled in the art are adequately familiar therewith.

For example, the one or more controllers 60 may be a PC based implementation of a central control processing system utilizing a central processing unit (CPU), memories 80 and an interconnect bus. The CPU may contain a single microprocessor, or it may contain a plurality of microprocessors for configuring the CPU as a multi-processor system. The memories include a main memory 80, such as a dynamic random access memory 80 (DRAM) and cache, as well as a read only memory 80, such as a PROM, EPROM, FLASH-EPROM, or the like. The system may also include any form of volatile or non-volatile memory 80. In operation, the main memory stores at least portions of instructions for execution by the CPU and data for processing in accord with the executed instructions.

The one or more controllers 60 may also include one or more input/output interfaces for communications with one or more processing systems. Although not shown, one or more such interfaces may enable communications via a network, e.g., to enable sending and receiving instructions electronically. The communication links may be wired or wireless.

The one or more controllers 60 may further include appropriate input/output ports for interconnection with one or more output displays and one or more input mechanisms serving as one or more user interfaces 70 for the controller 60. For example, the one or more controllers 60 may include a graphics subsystem to drive the output display. The links of the peripherals to the system may be wired connections or use wireless communications.

Although summarized above as a PC-type implementation, those skilled in the art will recognize that the one or more controllers 60 also encompasses systems such as host computers, servers, workstations, network terminals, and the like. In fact, the use of the term controller 60 is intended to represent a broad category of components that are well known in the art.

Aspects of the systems and methods provided herein encompass hardware and software for controlling the relevant functions. Software may take the form of code or executable instructions for causing a controller 60 or other programmable equipment to perform the relevant steps, where the code or instructions are carried by or otherwise embodied in a medium readable by the controller 60 or other machine. Instructions or code for implementing such operations may be in the form of computer instruction in any form (e.g., source code, object code, interpreted code, etc.) stored in or carried by any tangible readable medium.

As used herein, terms such as computer or machine “readable medium” refer to any medium that participates in providing instructions to a processor for execution. Such a medium may take many forms. Non-volatile storage media include, for example, optical or magnetic disks, such as any of the storage devices in any computer(s) shown in the drawings. Volatile storage media include dynamic memory 80, such as main memory 80 of such a computer platform. Common forms of computer-readable media therefore include for example: a floppy disk, a flexible disk, hard disk, magnetic tape, any other magnetic medium, a CD-ROM, DVD, any other optical medium, punch cards paper tape, any other physical medium with patterns of holes, a RAM, a PROM and EPROM, a FLASH-EPROM, any other memory chip or cartridge, or any other medium from which a computer can read programming code and/or data. Many of these forms of computer readable media may be involved in carrying one or more sequences of one or more instructions to a processor for execution.

It should be noted that various changes and modifications to the presently preferred embodiments described herein will be apparent to those skilled in the art. Such changes and modifications may be made without departing from the spirit and scope of the present invention and without diminishing its attendant advantages.

I claim:

1. A system for recording data comprising:
a controller;
a database;
a user interface; and
a memory including instructions, that when executed by the controller, cause it to perform the steps of:
receiving data, via the user interface, from a user;
storing, in the database, a record including the data, a timestamp of the time the data was received by the controller, and a unique identifier, wherein the unique identifier includes one or more digits, wherein the one or more digits of the unique identifier include one or more digits of the timestamp and a serial number, wherein the serial number is one of the group comprising: one or more digits of a sequential number relating to the order in which the data was received by the system relative to all other data received by the system, one or more digits of a cryptographic hash of the data, and one or more digits of a pseudo-random number;
displaying, via the user interface, a confirmation screen including the unique identifier;
receiving a request, via the user interface, including a second unique identifier, for a data record associated with the second unique identifier;
retrieving, from the database, a the data record associated with the second unique identifier; and
displaying, via the user interface, a data and a timestamp of the data record associated with the second unique identifier.

2. The system of claim 1, wherein the serial number is a sequential number relating to the order in which the data was received by the system relative to all other data received by the system.

3. The system of claim 1, wherein the serial number is a cryptographic hash of the data.

4. The system of claim 1, wherein the serial number is a pseudo-random number.

5. The system of claim 1, wherein the serial number includes: one or more digits of a sequential number relating to the order in which the data was received by the system relative to all other data received by the system, and one or more digits of a cryptographic hash of the data.

6. The system of claim 1, wherein the serial number includes: one or more digits of a sequential number relating to the order in which the data was received by the system relative to all other data received by the system, one or more digits of a cryptographic hash of the data, and one or more digits of a pseudo-random number.

7. The system of claim 1, wherein the one or more digits of the unique identifier including one or more digits of the timestamp are generated by concatenating, in order, two digits representing the month, two digits representing the day, four digits representing the year, two digits representing an hour, two digits representing the minutes, and five digits represent the seconds in milliseconds.

8. A method performed by a controller in communication with a database and a user interface comprising the steps of:
receiving data, via the user interface, from a user;
storing, in the database, a record including the data, a timestamp of the time the data was received by the controller, and a unique identifier, wherein the unique identifier includes one or more digits, wherein the one or more digits of the unique identifier include one or more digits of the timestamp and a serial number, wherein the serial number is one of the group comprising: one or more digits of a sequential number relating to the order in which the data was received by the system relative to all other data received by the system, one or more digits of a cryptographic hash of the data, and one or more digits of a pseudo-random number;
displaying, via the user interface, a confirmation screen including the unique identifier;
receiving a request, via the user interface, including a second unique identifier, for a data record associated with the second unique identifier;
retrieving, from the database, a the data record associated with the second unique identifier; and
displaying, via the user interface, a data and a timestamp of the data record associated with the second unique identifier.

9. The method of claim 8, wherein the serial number is a sequential number relating to the order in which the data was received by the system relative to all other data received by the system.

10. The method of claim 8, wherein the serial number is a cryptographic hash of the data.

11. The method of claim 8, wherein the serial number is a pseudo-random number.

12. The method of claim 8, wherein the serial number includes: one or more digits of a sequential number relating to the order in which the data was received by the system relative to all other data received by the system, and one or more digits of a cryptographic hash of the data.

13. The method of claim 8, wherein the serial number includes: one or more digits of a sequential number relating to the order in which the data was received by the system relative to all other data received by the system, one or more digits of a cryptographic hash of the data, and one or more digits of a pseudo-random number.

14. The method of claim 8, wherein the one or more digits of the unique identifier including one or more digits of the timestamp are generated by concatenating, in order, two digits representing the month, two digits representing the day, four digits representing the year, two digits representing an hour, two digits representing the minutes, and five digits represent the seconds in milliseconds.
